(19) United States
(12) Patent Application Publication
(10) Pub. No.: US 2026/0349737 A1
(43) Pub. Date: Nov. 5, 2026

(54) Method and apparatus for instruction tracing

(71) Applicants: Paul CARLSON, Hillsboro, OR (US); Zhong CHEN, Vancouver, WA (US); Pradeep SEBESTIAN, Beaverton, OR (US); Rahuldeva GHOSH, Portland, OR (US)

(72) Inventors: Paul CARLSON, Hillsboro, OR (US); Zhong CHEN, Vancouver, WA (US); Pradeep SEBESTIAN, Beaverton, OR (US); Rahuldeva GHOSH, Portland, OR (US)

(21) Appl. No.: 19/720,955

(22) Filed: Jun. 26, 2026

Related U.S. Application Data
(60) Provisional application No. 63/896,023, filed on Oct. 9, 2025.

(51) Int. Cl. G06F 9/30; G06F 9/38

(52) U.S. Cl. CPC G06F 9/3016; G06F 9/3808

(57) ABSTRACT

A method and apparatus for instruction tracing. Trace data is obtained and decoded to reconstruct an instruction sequence executed by a processor. A set of pre-determined function calls and/or a repeating code segment is skipped in decoding. The set of pre-determined function calls includes a function call that performs common actions that do not require a detailed instruction trace to comprehend, e.g., a call to an operating system (OS) application programming interface (API). The set of pre-determined function calls and/or the repeating code segment that are skipped in decoding are replaced in an output with either cached results or a tokenized representation to map to an original call.

### BACKGROUND

Instruction tracing is a technique that monitors and records the sequence of machine instructions actually executed by a processor during the runtime of a process. Because it captures the true, final-stage binary behavior of a program, independent of its source language, runtime environment, obfuscation scheme, or deployment mechanism, instruction tracing is widely regarded as the “holy grail” of execution analysis on endpoints. Practical use cases include, but are not limited to, threat analysis and malware detection, workload identification and profiling, anomaly and intrusion detection, and artificial intelligence/machine-learning (AI/ML)-based execution-context prediction.

### BRIEF DESCRIPTION OF THE FIGURES

Some examples of apparatuses and/or methods will be described in the following by way of example only, and with reference to the accompanying figures, in which

FIG. 1 is a block diagram of an example system for instruction tracing;

FIG. 2 is a flow diagram of an example method for instruction tracing;

FIG. 3 is a flow diagram of an example process for performing instruction tracing while skipping decoding of a set of pre-determined function calls (e.g., well-known operating system API calls) during instruction decoding with PT;

FIG. 4 is a flow diagram of an example process for performing instruction tracing while skipping decoding of repeated code segments during instruction decoding with PT;

FIG. 5 is a block diagram of an electronic apparatus incorporating at least one electronic assembly and/or method described herein;

FIG. 6 illustrates a computing device in accordance with one implementation of the invention; and

FIG. 7 is included to show an example of a higher-level device application for the disclosed embodiments.

### DETAILED DESCRIPTION

Various examples will now be described more fully with reference to the accompanying drawings in which some examples are illustrated. In the figures, the thicknesses of lines, layers and/or regions may be exaggerated for clarity.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

It will be understood that when an element is referred to as being “connected” or “coupled” to another element, the elements may be directly connected or coupled or via one or more intervening elements. If two elements A and B are combined using an “or”, this is to be understood to disclose all possible combinations, i.e. only A, only B as well as A and B. An alternative wording for the same combinations is “at least one of A and B”. The same applies for combinations of more than 2 elements.

The terminology used herein for the purpose of describing particular examples is not intended to be limiting for further examples. Whenever a singular form such as “a,” “an” and “the” is used and using only a single element is neither explicitly or implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises,” “comprising,” “includes” and/or “including,” when used, specify the presence of the stated features, integers, steps, operations, processes, acts, elements and/or components, but do not preclude the presence or addition of one or more other features, integers, steps, operations, processes, acts, elements, components and/or any group thereof.

Unless otherwise defined, all terms (including technical and scientific terms) are used herein in their ordinary meaning of the art to which the examples belong.

In the following description, specific details are set forth, but examples of the technologies described herein may be practiced without these specific details. Well-known circuits, structures, and techniques have not been shown in detail to avoid obscuring an understanding of this description. “An example,” “various examples,” “some examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform or resource, even though the instructions contained in the software or firmware are not actively being executed by the system, device, platform, or resource.

The description may use the phrases “in an example,” “in examples,” “in some examples,” and/or “in various examples,” each of which may refer to one or more of the same or different examples. Furthermore, the terms “comprising,” “including,” “having,” and the like, as used with respect to examples of the present disclosure, are synonymous.

Processor Trace (PT) is a hardware facility built into processors that enables the derivation of a live instruction trace of a process directly on an endpoint without requiring emulators, sandboxes, or software debuggers. PT works by having the CPU's on-chip tracing hardware observe control-flow events during normal process execution and emit a stream of trace packets into a dedicated memory buffer. These packets are sufficient to reconstruct the full instruction-level execution path when combined with the static code image resident in the process's virtual address space.

The PT packet types used in instruction trace reconstruction are target IP (TIP) packets, taken-not-taken (TNT) packets, flow update packets (FUP), MODE packets, and packet stream boundary (PSB) packets.

TIP packets are generated when the processor performs an indirect control-flow transfer whose destination cannot be statically inferred from the binary alone (e.g., indirect calls, indirect jumps, function returns). A TIP packet records the exact destination instruction pointer (IP) value to which control was transferred, allowing a trace decoder to follow the execution path across indirect branches.

TNT packets are generated for conditional branch instructions. Rather than recording full destination addresses, a TNT packet encodes a sequence of single-bit outcomes (1=branch taken, 0=branch not taken) in a compact bit-field format.

FUP is generated in conjunction with asynchronous events such as hardware interrupts and exceptions, providing the source IP from which asynchronous control flow departed, enabling the decoder to handle non-deterministic control flow correctly.

MODE packets record changes in processor execution mode (e.g., transitions between 16-bit, 32-bit, and 64-bit mode, or between user space and kernel space), ensuring that the decoder uses the correct instruction-set decoding rules at each point in the trace.

PSB packets are periodic synchronization markers inserted into the trace stream that allow a decoder to begin decoding from an arbitrary offset in the packet buffer without needing to start from the very beginning of the trace.

To reconstruct the executed instruction sequence, a PT decoder reads the PT packet stream in conjunction with the process's memory image. Starting from a known instruction pointer (obtained from an initial TIP or PSB packet), the PT decoder fetches instruction bytes from the process's mapped memory pages and disassembles them one by one. For instructions whose successors are deterministic (e.g., direct unconditional jumps, sequential fall-through instructions), the next instruction pointer is computed algebraically without consuming any PT packet data. For conditional branches, the decoder consumes the next TNT bit to determine whether execution continued at the fall-through address or at the branch target. For indirect branches, the decoder consumes a TIP packet to obtain the precise destination address. This process repeats, instruction by instruction, to reconstruct the complete opcode sequence executed by the process.

Instruction disassembly from process-executable memory bytes is performed by a decoder library such as XED (the X86 Encoder Decoder library). XED parses variable-length x86/x64 instruction encodings, and produces structured information about each instruction, including its opcode, operands, and length. Because modern processes execute an extremely high volume of instructions, and because tracing instruction execution may require multiple memory reads and XED library calls to decode, the cumulative compute and memory cost of decoding instructions at runtime from a full PT trace is substantial. This cost is the primary reason PT-based instruction tracing has not been widely deployed on production endpoints, particularly client devices with limited resources.

Therefore, methods and techniques to reduce the volume of instruction decoding, while retaining mission-critical data (e.g., for threat analysis), are necessary to make low-overhead, scalable execution tracing viable directly on live endpoints. No viable solution exists today for runtime instruction tracing at scale on endpoints with the efficiency and low overhead required for frequent and reliable execution, especially on client devices. The conventional approaches explained below suffer from fundamental limitations.

Software emulators replicate a CPU's instruction-execution behavior in software. They can provide detailed instruction traces but are inherently slow, memory-intensive, and should be initiated from the very beginning of a process's lifecycle (i.e., from process launch). Attaching an emulator to an already-running process is generally not feasible. Furthermore, many modern malware families include anti-emulation techniques that detect the behavioral artifacts of software emulation and suppress or alter their payload accordingly. Emulation is therefore typically confined to cloud-based sandboxes.

Software debuggers can attach to running processes and collect instruction traces. However, they do so by injecting software breakpoints or by using hardware debug registers (which are limited in number). The overhead of frequent breakpoint interrupts, coupled with the intrusiveness of the debugger's presence, makes debugger-based tracing unsuitable for production endpoint use at scale. Additionally, malware routinely employs anti-debugging techniques to detect and evade debugger attachment.

PT-based control-flow tracing provides accurate runtime instruction trace derivation from control-flow trace data combined with reading process memory. However, the volume of data generated and the computational cost of decoding it make scaling such tracing difficult without significant optimizations. The techniques disclosed herein are designed to address this problem.

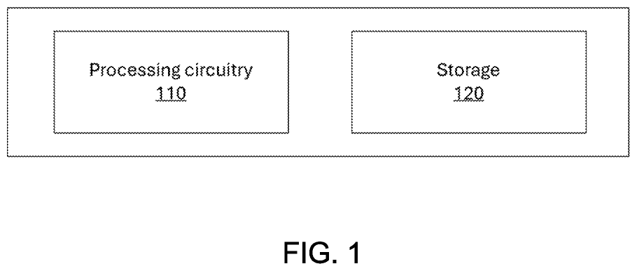

FIG. 1 is a block diagram of an example apparatus for instruction tracing. The apparatus 100 includes processing circuitry 110 and storage 120. The processing circuitry 110 is configured to receive a trace packet stream generated by a processor (not shown separately in FIG. 1) during execution of a process. The processor executes the target process and generates a trace packet stream. The processor and the processing circuitry 110 may be the same (self-tracing) or may be different units. The processor may include built-in tracing hardware that observes control-flow events during execution of a process and generates a stream of trace packets (a trace packet stream) into a dedicated memory (buffer). A trace packet stream is an ordered sequence of Processor Trace (PT) packet data. The trace packet stream is the primary information source used to resolve the next instruction pointer at conditional and indirect branches during instruction trace reconstruction. The trace packet stream may include target IP (TIP) packets and taken-not-taken (TNT) packets generated by PT.

The processing circuitry 110 is configured to decode the trace packet stream to reconstruct an instruction sequence executed by the processor during execution of the process. While decoding the trace packet stream, the processing circuitry 110 is configured to skip instructions belonging to a set of pre-determined function calls or instructions belonging to a repeated code segment that has been previously decoded and cached, which will be explained in detail below. The processing circuitry 110 is configured to generate a trace output based on the reconstructed instruction sequence. In the trace output, the processing circuitry 110 may be configured to insert a token representing the skipped instructions or a previously decoded instruction trace of the skipped instructions retrieved from a cache.

For example, the processing circuitry 110 may be configured to determine whether an instruction is a call instruction. If the instruction is a call instruction, the processing circuitry 110 may determine whether the call instruction is a call to the set of pre-determined function calls. If the call instruction is a call to the set of pre-determined function calls, the processing circuitry 110 may skip decoding instructions of the called function and insert a token representing the called function or a previously decoded instruction trace of the called function retrieved from a cache in the trace output. The processing circuitry 110 may be configured to set a current instruction pointer to a target address of the call instruction and resume the decoding from the target address if the call instruction is not a call to the set of pre-determined function calls.

In another example, the processing circuitry 110 may be configured to determine whether an instruction is a branch instruction and requires trace information to resolve a next instruction pointer. If the instruction is a conditional branch instruction and is a taken branch, or if the instruction is an indirect branch instruction, the processing circuitry 110 may determine whether a branch target is amongst cached segments. If the branch target is amongst the cached segments, the processing circuitry 110 may fetch a cached segment matching the branch target and determine whether branch traces of the cached segment match with a lookahead sequence of branch traces in the trace packet stream. If the branch traces of the cached segment match with the lookahead sequence of branch traces in the trace packet stream, the processing circuitry 110 may advance the trace packet stream past trace packets corresponding to the cached segment without decoding instructions of the cached segment. The processing circuitry 110 may be configured to, if the branch target is not amongst the cached segments, cache a current active segment and record branch trace information in a new active segment. The processing circuitry 110 may be configured to, if the instruction is not a taken branch, record branch trace information in the current active segment.

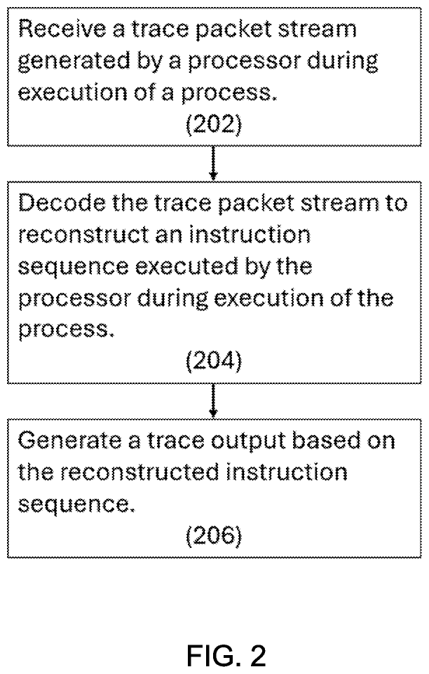

FIG. 2 is a flow diagram of an example method 200 for instruction tracing. The method 200 comprising receiving a trace packet stream generated by a processor during execution of a process (202). The trace packet stream may include TIP packets and TNT packets generated by PT. The method further comprises decoding the trace packet stream to reconstruct an instruction sequence executed by the processor during execution of the process (204). While decoding the trace packet stream, instructions belonging to a set of pre-determined function calls or instructions belonging to a repeated code segment that has been previously decoded and cached are skipped. The method further comprises generating a trace output based on the reconstructed instruction sequence (206).

Example schemes are disclosed herein to reduce the amount of PT-based instruction trace that should be decoded while retaining mission-significant data (e.g., for threat analysis and detection). These optimizations are necessary for viable low-overhead execution tracing that can be performed directly on the endpoint on live processes.

Two example techniques are disclosed herein, which may be applied independently or in combination. The first example technique is skipping decoding of a set of pre-determined function calls (e.g., well-known operating system (OS) application programming interface (API) calls). The second example technique is skipping decoding of repeated code segments by caching and reusing previously decoded segment traces. When applied together, these techniques yield the greatest reduction in decoding overhead and are expected to make runtime instruction tracing practical at scale on endpoint devices.

A general PT-based instruction trace reconstruction process is described as follows. A tracing session is configured by specifying which process, thread, or CPU core is to be traced. PT is enabled via OS-provided interfaces. The target process continues to run normally while the CPU's PT hardware silently observes its control-flow behavior and emits a stream of trace packets (TIP, TNT, FUP, MODE, PSB, etc.) into a buffer.

When the tracing session ends (or when the buffer fills), a PT decoder reads the packet stream. Beginning from the instruction pointer established by the first PSB or TIP packet, the decoder performs the following per-instruction loop. The decoder fetches instruction bytes from the process's virtual memory image at the current instruction pointer, and invokes the instruction disassembler (e.g., XED) to decode the instruction bytes, obtaining the instruction's opcode, operand types, byte length.

The decoder determines the type of the decoded instruction. If it is a non-branching instruction (e.g., arithmetic, logic, memory access), the decoder advances the instruction pointer by the instruction's byte length and proceeds to the next instruction. If it is a direct unconditional branch (e.g., a JMP with an immediate offset), the decoder computes the next instruction pointer from the instruction's encoded offset without consuming any trace packet data. If it is a conditional branch, the decoder consumes the next TNT bit from the current TNT packet. If the bit indicates “taken,” the decoder jumps to the encoded branch target, otherwise, advances to the fall-through address. If it is an indirect branch (indirect call, indirect jump, or return), the decoder consumes the next TIP packet from the trace stream to obtain the precise destination instruction pointer. The decoder records the decoded instruction (e.g., its opcode and operands) in the output instruction trace. The decoder repeats for the next instruction.

This per-instruction loop is computationally expensive because every iteration requires a memory access to fetch instruction bytes, an XED library call to decode them, and conditional packet consumption from the trace stream. For a typical process executing millions of instructions per second, even a brief tracing window can require decoding hundreds of millions of instructions. The two optimization schemes disclosed herein directly target this bottleneck.

In a first example scheme, the decoder may skip decoding pre-determined function calls. The set of pre-determined function calls may include calls to one or more functions exported by a shared library loaded into a virtual address space of the process (e.g., well-known OS API calls). A large fraction of the instructions executed by any typical process belong to well-known, standardized library routines (e.g., OS API calls). OS APIs (system calls or library calls) are functions exported by OS-provided shared libraries that applications invoke to perform standard operations such as file I/O, memory allocation, network communication, or process management. Because these functions are part of the OS's stable, well-documented interface, their behavior is thoroughly known a priori and does not need to be re-derived from a fresh instruction trace for each invocation.

A list of function-call targets (a set of pre-determined function calls) may be skipped during decoding. This list may be pre-populated with the entry-point addresses of well-known OS API functions and may be extended to include any other well-known function calls (e.g., widely-used third-party library functions) whose internals are sufficiently understood and do not require per-invocation tracing.

During instruction trace reconstruction, when the decoder encounters a call instruction, the decoder checks whether the call target address is present in the list of pre-determined function calls. If the call target is found in the list (indicating a call to a pre-determined function), the decoder skips instruction tracing and may generate a token or symbolic identifier in the output trace that represents the skipped function call. The token may encode the identity of the called function and serves as a substitute for the entire instruction trace of the called function.

If the function call has been decoded in a prior tracing session or earlier in the current session, the decoder may alternatively substitute the previously cached instruction trace for the function, rather than generating a token or symbolic identifier.

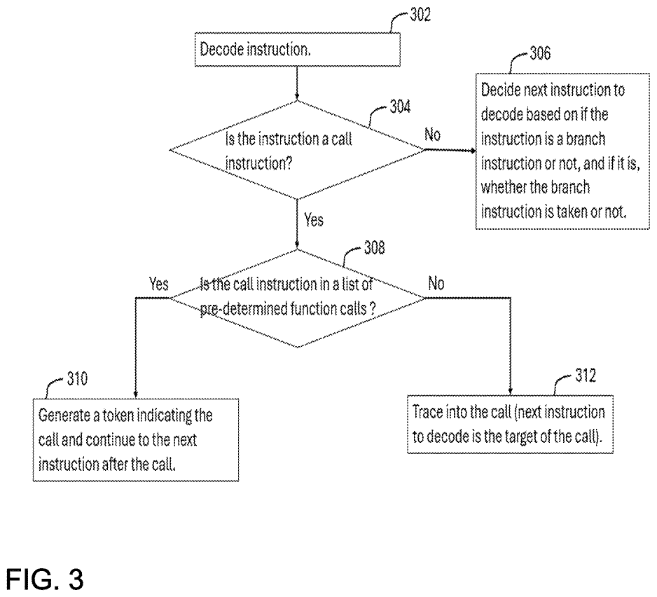

FIG. 3 is a flow diagram of an example process for performing instruction tracing while skipping decoding of a set of pre-determined function calls (e.g., well-known operating system API calls) during instruction decoding with PT. The decoder iterates over instructions in the trace packet stream. For each instruction, the decoder performs instruction decoding to identify the instruction type (302). The decoder then determines whether the instruction is a call instruction (304). If it is not a call instruction, the decoder determines the next instruction and proceeds to decode the next instruction (306). For example, the decoder determines the next instruction to decode based on if the instruction is a branch instruction or not, and if it is, whether the branch instruction is taken or not. If the instruction is a call instruction, the decoder determines whether the call instruction is in a list of pre-determined function calls (308). The list of pre-determined function calls may include calls to one or more functions exported by a shared library loaded into a virtual address space of the process. For example, the set of pre-determined function calls includes a call to an OS API. For example, the decoder may determine whether the call's target address is present in the pre-determined list.

If the call instruction is not in the list of pre-determined function calls, the decoder traces into the called function (312). In this case, the next instruction to decode is the target of the call. The decoder sets the current instruction pointer to the call target and continues decoding from within the function body. The decoder may set a current instruction pointer to a target address of the call instruction and resume decoding from the target address if the call instruction is not a call to the set of pre-determined function calls.

If the call instruction is in the list of pre-determined function calls, the decoder skips decoding instructions of the called function, and generates a token representing the call, or alternatively substitutes cached results, and continues to the next instruction after the call (310). The decoder may advance past the function body by consuming the corresponding PT packets up to and including the matching return, and resumes decoding at the return address.

In a second example scheme, the decoder may skip decoding repeated code segments. One of the major sources of redundant instruction decoding arises from the repeated execution of the same code sequences. Processes frequently execute the same instruction sequences multiple times due to programming constructs such as loops (e.g., for, while, do-while), recursive function calls, event-processing loops, and other repetitive patterns. The instruction sequence within a loop body may be executed thousands or millions of times during a single tracing session. Decoding the same sequence of instructions repeatedly from scratch each time it is executed is wasteful, since the instructions themselves are static and only the branch outcomes (encoded in TNT and TIP packets) may vary between iterations.

This redundancy is exploited by caching the decoded instruction sequence for each distinct code segment the first time it is decoded. On subsequent executions of the same code segment, the decoder may verify (e.g., using lookahead inspection of the PT packet stream) that the same sequence of branch outcomes was taken (meaning that the code segment was executed identically to a prior execution), and if so, reuse the cached trace segment instead of re-decoding it instruction by instruction.

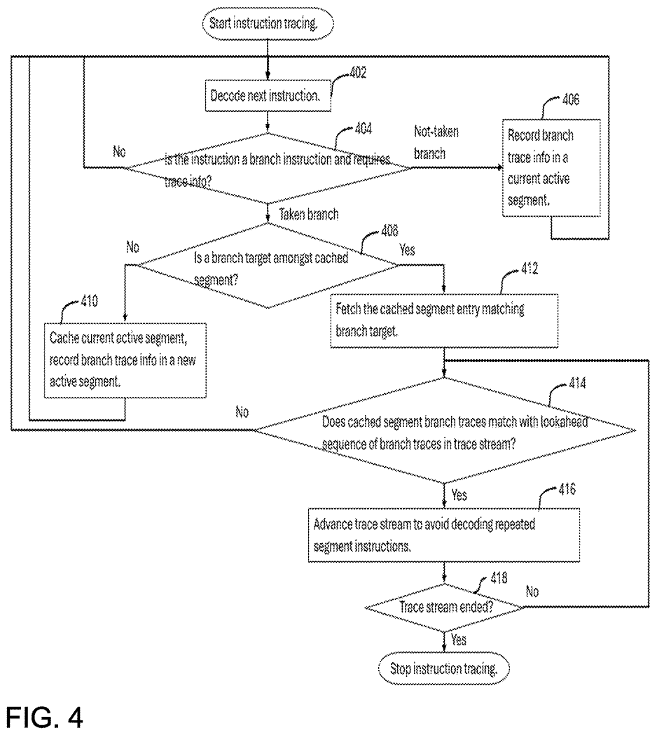

FIG. 4 is a flow diagram of an example process for performing instruction tracing while skipping decoding of repeated code segments during instruction decoding with PT. The decoder decodes an instruction (402). The decoder begins decoding from the current instruction pointer and opens a new active segment. A segment records trace information for decoded branch instructions. An active segment is the segment currently being decoded. The active segment accumulates branch trace entries as each branch instruction is decoded. The active segment is closed when a taken branch is encountered, at which point the active segment is stored in a segment cache, and a new active segment is started at the taken branch's destination. A branch trace is a sequence of per-instruction branch outcomes recorded during the decoding. For each conditional branch instruction encountered during decoding, the branch trace records a taken/not-taken indicator (derived from the TNT packet). For each indirect branch instruction, the branch trace records the destination instruction pointer (derived from a TIP packet). The branch trace fully characterizes the control-flow behavior of a segment in a given execution.

For each instruction decoded, the decoder determines whether the instruction is a branch instruction that requires trace information (PT packet data) to resolve its next instruction pointer (e.g., a conditional branch or indirect branch) (404). Direct unconditional branches are resolved algebraically and do not consume PT packet data. If the instruction is not a branch instruction or does not require trace information to resolve its next instruction pointer (e.g., a non-branching instruction or a direct unconditional branch), the decoder records no branch trace entry and proceeds to decode the next instruction at 402.

If the instruction is a branch instruction that requires trace information to resolve its next instruction pointer, the decoder determines whether the branch was taken or not (e.g., by reading the next TNT bit from the trace stream). If the branch is a not-taken branch (e.g., if TNT bit=0), the decoder records the branch trace information in the current active segment (406). The branch trace of the active segment is updated with a ‘not-taken’ entry, and the decoder continues decoding at the fall-through address.

If the instruction is a taken branch (a taken conditional branch or an indirect branch), the decoder determines whether the branch target is amongst the cached segments (408). The decoder checks the segment cache for an entry of the branch target. An entry in the segment cache represents a segment that has been decoded at least once before.

If the branch target is not in the segment cache, the decoder closes the current active segment by storing it in the segment cache, opens a new active segment beginning at the branch target, and records the taken-branch trace entry in the new active segment (410). Instruction decoding continues normally from the branch target.

If the branch target is found in the segment cache, the decoder fetches the cached segment entry matching the branch target (412). The decoder then performs a lookahead comparison. The decoder determines whether the cached segment branch traces match with a lookahead sequence of branch traces in trace packet stream (414). A lookahead sequence is a forward-looking inspection of upcoming PT packet data in the trace stream, performed without permanently consuming the data. The lookahead examines the next N branch trace entries available in the trace stream and compares them against the branch trace recorded in a cached segment to determine whether the current execution of that segment is following the same path as the cached execution. The decoder reads ahead in the trace packet stream to determine whether the next N branch trace entries in the stream match the branch trace recorded in the cached segment.

If the lookahead matches (i.e., the current execution of the segment follows the same control-flow path as the cached execution), the decoder advances the trace stream to avoid decoding repeated segment instructions (416). The decoder skips re-decoding the segment's instructions. In examples, the decoder may output the cached decoded instruction sequence (or a token/reference representing it) and advances the trace stream consumption position past the matching trace data, effectively skipping N branch trace entries'worth of PT packets. Decoding then resumes at the instruction pointer following the end of the cached segment. If the lookahead does not match (i.e., the current execution diverges from the cached path), the decoder falls through to normal per-instruction decoding from the branch target, updating the cached segment entry as needed. If the trace stream ends (418), the instruction tracing ends.

The lookahead comparison ensures that the cached segment is only reused when it is safe to do so, i.e., when the current execution of the code segment is truly following the same branch path as a prior execution. This guards against incorrectly reusing a cached segment in cases where the same starting instruction pointer is reached via a different control-flow path or with different branch outcomes (e.g., a loop that iterates a different number of times, or a conditional block within the loop that branches differently in different iterations).

The above two example techniques may be applied separately or in combination. In combined operation, the decoder first checks whether a call instruction targets a pre-determined function, if so, the decoder skips the entire function body. For all other codes, the decoder applies the second example technique to cache and reuse instruction traces for repeated code segments.

Without the application of these techniques, the computational cost of tracing processes, most of which contain a significant number of loop implementations and OS API calls, in near real time and with low compute overhead on an endpoint would be extremely difficult, if not practically impossible.

Runtime process execution tracing-based program analysis has long been among the most sought-after and valued techniques for endpoint security and workload analysis. The ability to read a process's executed instruction stream at its final point of execution, in its most fundamental form (opcodes), provides the means to examine a program's true behavior irrespective of its coding language, runtime environment, obfuscation scheme, packing, or deployment method. This is particularly valuable for detecting advanced persistent threats, polymorphic malware, and other sophisticated attack payloads that evade signature-based and behavioral detectors by masking their true actions.

The techniques disclosed herein enable efficient, low-overhead PT-based instruction tracing at scale on endpoints, including resource-constrained client devices. Security solutions such as deep learning-and trace-based execution context trackers that analyze and predict execution context from runtime instruction streams stand to greatly benefit from the optimized instruction trace data produced by these techniques.

Reducing the instruction tracing space by applying the optimization techniques disclosed herein would also benefit AI/ML solutions that analyze and predict the execution context from runtime instruction streams. Smaller, more compact instruction traces (achieved by replacing repeated segments and known API calls with tokens or cached representations) reduce the input dimensionality for such models, improving inference speed and reducing memory footprint.

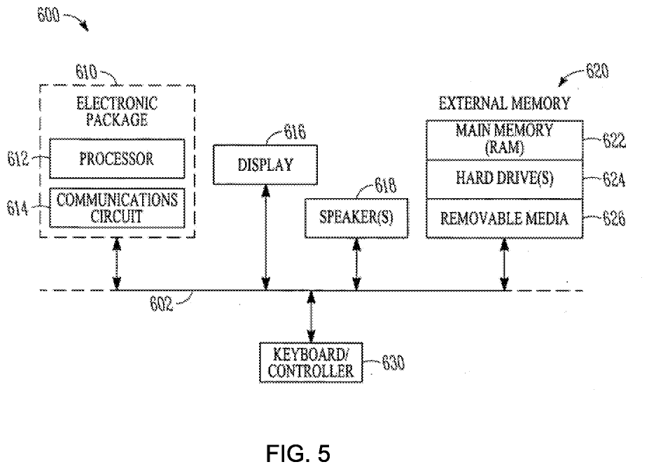

FIG. 5 is a block diagram of an electronic apparatus 600 incorporating at least one electronic assembly and/or method described herein. Electronic apparatus 600 is-merely one example of an electronic apparatus in which forms of the electronic assemblies and/or methods described herein may be used. Examples of an electronic apparatus 600 include, but are not limited to, personal computers, tablet computers, mobile telephones, game devices, MP3 or other digital music players, etc. In this example, electronic apparatus 600 comprises a data processing system that includes a system bus 602 to couple the various components of the electronic apparatus 600. System bus 602 provides communications links among the various components of the electronic apparatus 600 and may be implemented as a single bus, as a combination of busses, or in any other suitable manner.

An electronic assembly 610 as describe herein may be coupled to system bus 602. The electronic assembly 610 may include any circuit or combination of circuits. In one embodiment, the electronic assembly 610 includes a processor 612 which can be of any type. As used herein, “processor” means any type of computational circuit, such as but not limited to a microprocessor, a microcontroller, a complex instruction set computing (CISC) microprocessor, a reduced instruction set computing (RISC) microprocessor, a very long instruction word (VLIW) microprocessor, a graphics processor, a digital signal processor (DSP), multiple core processor, or any other type of processor or processing circuit.

Other types of circuits that may be included in electronic assembly 610 are a custom circuit, an application-specific integrated circuit (ASIC), or the like, such as, for example, one or more circuits (such as a communications circuit 614) for use in wireless devices like mobile telephones, tablet computers, laptop computers, two-way radios, and similar electronic systems. The IC can perform any other type of function.

The electronic apparatus 600 may also include an external memory 620, which in turn may include one or more memory elements suitable to the particular application, such as a main memory 622 in the form of random access memory (RAM), one or more hard drives 624, and/or one or more drives that handle removable media 626 such as compact disks (CD), ﬂash memory cards, digital video disk (DVD), and the like.

The electronic apparatus 600 may also include a display device 616, one or more speakers 618, and a keyboard and/or controller 630, which can include a mouse, trackball, touch screen, voice-recognition device, or any other device that permits a system user to input information into and receive information from the electronic apparatus 600.

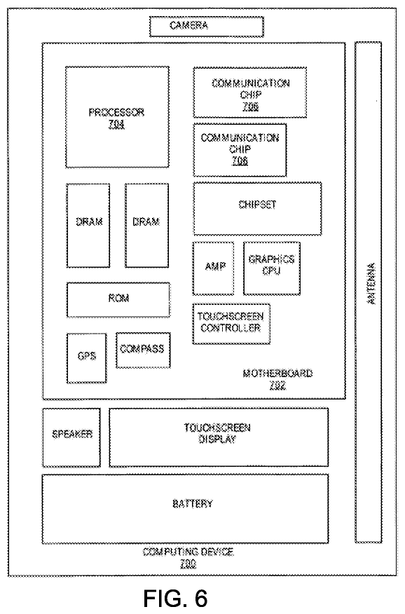

FIG. 6 illustrates a computing device 700 in accordance with one implementation of the invention. The computing device 700 houses a board 702. The board 702 may include a number of components, including but not limited to a processor 704 and at least one communication chip 706. The processor 704 is physically and electrically coupled to the board 702. In some implementations the at least one communication chip 706 is also physically and electrically coupled to the board 702. In further implementations, the communication chip 706 is part of the processor 704. Depending on its applications, computing device 700 may include other components that may or may not be physically and electrically coupled to the board 702. These other components include, but are not limited to, volatile memory (e.g., DRAM), non-volatile memory (e.g., ROM), flash memory, a graphics processor, a digital signal processor, a crypto processor, a chipset, an antenna, a display, a touchscreen display, a touchscreen controller, a battery, an audio codec, a video codec, a power amplifier, a global positioning system (GPS) device, a compass, an accelerometer, a gyroscope, a speaker, a camera, and a mass storage device (such as hard disk drive, compact disk (CD), digital versatile disk (DVD), and so forth). The communication chip 706 enables wireless communications for the transfer of data to and from the computing device 700. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 706 may implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing device 700 may include a plurality of communication chips 706. For instance, a first communication chip 706 may be dedicated to shorter range wireless communications such as Wi-Fi and Bluetooth and a second communication chip 706 may be dedicated to longer range wireless communications such as GPS, EDGE, GPRS, CDMA, WiMAX, LTE, Ev-DO, and others. The processor 704 of the computing device 700 includes an integrated circuit die packaged within the processor 704. In some implementations of the invention, the integrated circuit die of the processor includes one or more devices that are assembled in an ePLB or eWLB based P0P package that that includes a mold layer directly contacting a substrate, in accordance with implementations of the invention. The term “processor” may refer to any device or portion of a device that processes electronic data from registers and/or memory to transform that electronic data into other electronic data that may be stored in registers and/or memory. The communication chip 706 also includes an integrated circuit die packaged within the communication chip 706. In accordance with another implementation of the invention, the integrated circuit die of the communication chip includes one or more devices that are assembled in an ePLB or eWLB based P0P package that that includes a mold layer directly contacting a substrate, in accordance with implementations of the invention.

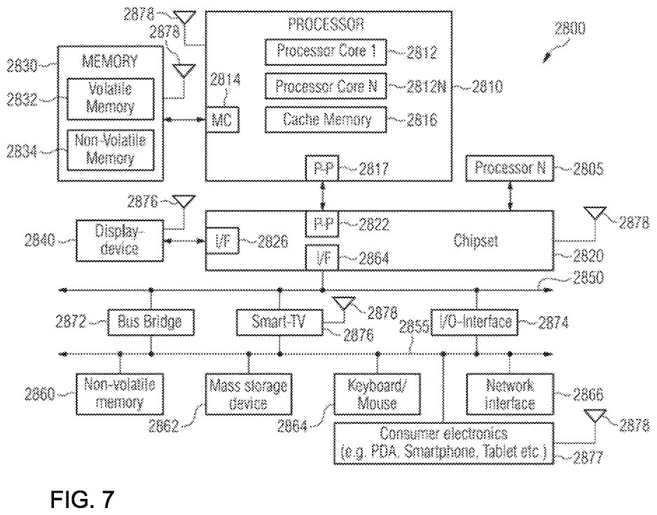

FIG. 7 is included to show an example of a higher level device application for the disclosed embodiments. The MAA cantilevered heat pipe apparatus embodiments may be found in several parts of a computing system. In an embodiment, the MAA cantilevered heat pipe is part of a communications apparatus such as is affixed to a cellular communications tower. The MAA cantilevered heat pipe may also be referred to as an MAA apparatus. In an embodiment, a computing system 2800 includes, but is not limited to, a desktop computer. In an embodiment, a system 2800 includes, but is not limited to a laptop computer. In an embodiment, a system 2800 includes, but is not limited to a netbook. In an embodiment, a system 2800 includes, but is not limited to a tablet. In an embodiment, a system 2800 includes, but is not limited to a notebook computer. In an embodiment, a system 2800 includes, but is not limited to a personal digital assistant (PDA). In an embodiment, a system 2800 includes, but is not limited to a server. In an embodiment, a system 2800 includes, but is not limited to a workstation. In an embodiment, a system 2800 includes, but is not limited to a cellular telephone. In an embodiment, a system 2800 includes, but is not limited to a mobile computing device. In an embodiment, a system 2800 includes, but is not limited to a smart phone. In an embodiment, a system 2800 includes, but is not limited to an internet appliance. Other types of computing devices may be configured with the microelectronic device that includes MAA apparatus embodiments.

In an embodiment, the processor 2810 has one or more processing cores 2812 and 2812N, where 2812N represents the Nth processor core inside processor 2810 where N is a positive integer. In an embodiment, the electronic device system 2800 using a MAA apparatus embodiment that includes multiple processors including 2810 and 2805, where the processor 2805 has logic similar or identical to the logic of the processor 2810. In an embodiment, the processing core 2812 includes, but is not limited to, pre-fetch logic to fetch instructions, decode logic to decode the instructions, execution logic to execute instructions and the like. In an embodiment, the processor 2810 has a cache memory 2816 to cache at least one of instructions and data for the MAA apparatus in the system 2800. The cache memory 2816 may be organized into a hierarchal structure including one or more levels of cache memory.

In an embodiment, the processor 2810 includes a memory controller 2814, which is operable to perform functions that enable the processor 2810 to access and communicate with memory 2830 that includes at least one of a volatile memory 2832 and a non-volatile memory 2834. In an embodiment, the processor 2810 is coupled with memory 2830 and chipset 2820. The processor 2810 may also be coupled to a wireless antenna 2878 to communicate with any device configured to at least one of transmit and receive wireless signals. In an embodiment, the wireless antenna interface 2878 operates in accordance with, but is not limited to, the IEEE 802.11 standard and its related family, Home Plug AV (HPAV), Ultra Wide Band (UWB), Bluetooth, WiMax, or any form of wireless communication protocol.

In an embodiment, the volatile memory 2832 includes, but is not limited to, Synchronous Dynamic Random Access Memory (SDRAM), Dynamic Random Access Memory (DRAM), RAMBUS Dynamic Random Access Memory (RDRAM), and/or any other type of random access memory device. The non-volatile memory 2834 includes, but is not limited to, flash memory, phase change memory (PCM), read-only memory (ROM), electrically erasable programmable read-only memory (EEPROM), or any other type of non-volatile memory device.

The memory 2830 stores information and instructions to be executed by the processor 2810. In an embodiment, the memory 2830 may also store temporary variables or other intermediate information while the processor 2810 is executing instructions. In the illustrated embodiment, the chipset 2820 connects with processor 2810 via Point-to-Point (PtP or P-P) interfaces 2817 and 2822. Either of these PtP embodiments may be achieved using a MAA apparatus embodiment as set forth in this disclosure. The chipset 2820 enables the processor 2810 to connect to other elements in the MAA apparatus embodiments in a system 2800. In an embodiment, interfaces 2817 and 2822 operate in accordance with a PtP communication protocol such as the Intel® QuickPath Interconnect (QPI) or the like. In other embodiments, a different interconnect may be used.

In an embodiment, the chipset 2820 is operable to communicate with the processor 2810, 2805N, the display device 2840, and other devices 2872, 2876, 2874, 2860, 2862, 2864, 2866, 2877, etc. The chipset 2820 may also be coupled to a wireless antenna 2878 to communicate with any device configured to at least do one of transmit and receive wireless signals.

The chipset 2820 connects to the display device 2840 via the interface 2826. The display 2840 may be, for example, a liquid crystal display (LCD), a plasma display, cathode ray tube (CRT) display, or any other form of visual display device. In and embodiment, the processor 2810 and the chipset 2820 are merged into a MAA apparatus in a system. Additionally, the chipset 2820 connects to one or more buses 2850 and 2855 that interconnect various elements 2874, 2860, 2862, 2864, and 2866. Buses 2850 and 2855 may be interconnected together via a bus bridge 2872 such as at least one MAA apparatus embodiment. In an embodiment, the chipset 2820 couples with a non-volatile memory 2860, a mass storage device(s) 2862, a keyboard/mouse 2864, and a network interface 2866 by way of at least one of the interface 2824 and 2874, the smart TV 2876, and the consumer electronics 2877, etc.

In an embodiment, the mass storage device 2862 includes, but is not limited to, a solid state drive, a hard disk drive, a universal serial bus flash memory drive, or any other form of computer data storage medium. In one embodiment, the network interface 2866 is implemented by any type of well-known network interface standard including, but not limited to, an Ethernet interface, a universal serial bus (USB) interface, a Peripheral Component Interconnect (PCI) Express interface, a wireless interface and/or any other suitable type of interface. In one embodiment, the wireless interface operates in accordance with, but is not limited to, the IEEE 802.11 standard and its related family, Home Plug AV (HPAV), Ultra Wide Band (UWB), Bluetooth, WiMax, or any form of wireless communication protocol.

While the modules shown in FIG. 7 are depicted as separate blocks within the MAA apparatus embodiment in a computing system 2800, the functions performed by some of these blocks may be integrated within a single semiconductor circuit or may be implemented using two or more separate integrated circuits. For example, although cache memory 2816 is depicted as a separate block within processor 2810, cache memory 2816 (or selected aspects of 2816) can be incorporated into the processor core 2812.

Where useful, the computing system 2800 may have a broadcasting structure interface such as for affixing the MAA apparatus to a cellular tower.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions or computer program products as well as any data created and/or used during implementation of the disclosed technologies can be stored on one or more tangible or non-transitory computer-readable storage media, such as volatile memory (e.g., DRAM, SRAM), non-volatile memory (e.g., flash memory, chalcogenide-based phase-change non-volatile memory) optical media discs (e.g., DVDs, CDs), and magnetic storage (e.g., magnetic tape storage, hard disk drives). Computer-readable storage media can be contained in computer-readable storage devices such as solid-state drives, USB flash drives, and memory modules. Alternatively, any of the methods disclosed herein (or a portion) thereof may be performed by hardware components comprising non-programmable circuitry. In some examples, any of the methods herein can be performed by a combination of non-programmable hardware components and one or more processing units executing computer-executable instructions stored on computer-readable storage media.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C #, Java, Perl, Python, JavaScript, Adobe Flash, C #, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

As used in this application and the claims, a list of items joined by the term “and/or” can mean any combination of the listed items. For example, the phrase “A, B and/or C” can mean A; B; C; A and B; A and C; B and C; or A, B and C. As used in this application and the claims, a list of items joined by the term “at least one of” can mean any combination of the listed terms. For example, the phrase “at least one of A, B or C” can mean A; B; C; A and B; A and C; B and C; or A, B, and C. Moreover, as used in this application and the claims, a list of items joined by the term “one or more of” can mean any combination of the listed terms. For example, the phrase “one or more of A, B and C” can mean A; B; C; A and B; A and C; B and C; or A, B, and C.

The disclosed methods, apparatuses, and systems are not to be construed as limiting in any way. Instead, the present disclosure is directed toward all novel and nonobvious features and aspects of the various disclosed examples, alone and in various combinations and sub-combinations with one another. The disclosed methods, apparatuses, and systems are not limited to any specific aspect or feature or combination thereof, nor do the disclosed examples require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

Although the operations of some of the disclosed methods are described in a particular, sequential order for convenient presentation, it is to be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods can be used in conjunction with other methods.

Another example is a computer program having a program code for performing at least one of the methods described herein, when the computer program is executed on a computer, a processor, or a programmable hardware component. Another example is a machine-readable storage including machine readable instructions, when executed, to implement a method or realize an apparatus as described herein. A further example is a machine-readable medium including code, when executed, to cause a machine to perform any of the methods described herein.

The examples as described herein may be summarized as follows.

An example (e.g., example 1) relates to a computer-readable medium comprising a code that, when the code is executed on a processor, causes the processor to: receive a trace packet stream generated by a processor during execution of a process, decode the trace packet stream to reconstruct an instruction sequence executed by the processor during execution of the process, wherein the code is configured to skip instructions belonging to a set of pre-determined function calls or instructions belonging to a repeated code segment that has been previously decoded and cached, and generate a trace output based on the reconstructed instruction sequence.

Another example, (e.g., example 2) relates to a previously described example (e.g., example 1), wherein the code is configured to insert a token representing the skipped instructions or a previously decoded instruction trace of the skipped instructions retrieved from a cache in the trace output.

Another example, (e.g., example 3) relates to a previously described example (e.g., any one of examples 1-2), wherein the code is configured to: determine whether an instruction is a call instruction, if the instruction is a call instruction, determine whether the call instruction is a call to the set of pre-determined function calls, and if the call instruction is a call to the set of pre-determined function calls, skip decoding instructions of the called function and insert a token representing the called function or a previously decoded instruction trace of the called function retrieved from a cache in the trace output.

Another example, (e.g., example 4) relates to a previously described example (e.g., example 3), wherein the code is configured to set a current instruction pointer to a target address of the call instruction and resume decoding from the target address if the call instruction is not a call to the set of pre-determined function calls.

Another example, (e.g., example 5) relates to a previously described example (e.g., any one of examples 1-4), wherein the set of pre-determined function calls includes calls to one or more functions exported by a shared library loaded into a virtual address space of the process.

Another example, (e.g., example 6) relates to a previously described example (e.g., example 5), wherein the set of pre-determined function calls includes a call to an operating system (OS) application programming interface (API).

Another example, (e.g., example 7) relates to a previously described example (e.g., any one of examples 1-6), wherein the code is configured to: determine whether an instruction is a branch instruction and requires trace information to resolve a next instruction pointer, if the instruction is a taken branch, determine whether a branch target is amongst cached segments, if the branch target is amongst the cached segments, fetch a cached segment matching the branch target, and determine whether branch traces of the cached segment match with a lookahead sequence of branch traces in the trace packet stream, and if the branch traces of the cached segment match with the lookahead sequence of branch traces in the trace packet stream, advance the trace packet stream past trace packets corresponding to the cached segment without decoding instructions of the cached segment.

Another example, (e.g., example 8) relates to a previously described example (e.g., example 7), wherein the code is configured to, if the branch target is not amongst the cached segments, cache a current active segment in a segment cache and record branch trace information in a new active segment.

Another example, (e.g., example 9) relates to a previously described example (e.g., any one of examples 1-8), wherein the code is configured to, if the instruction is a not-taken branch, record branch trace information in the current active segment.

Another example, (e.g., example 10) relates to a previously described example (e.g., any one of examples 1-9), wherein the trace packet stream is generated by Processor Trace (PT).

Another example, (e.g., example 11) relates to a previously described example (e.g., example 10), wherein the trace packet stream comprises target IP (TIP) packets and taken-not-taken (TNT) packets.

Another example, (e.g., example 12) relates to an apparatus for instruction tracing, the apparatus comprising processing circuitry configured to: receive a trace packet stream generated by a processor during execution of a process, decode the trace packet stream to reconstruct an instruction sequence executed by the processor during execution of the process, wherein decoding comprises skipping instructions belonging to a set of pre-determined function calls or instructions belonging to a repeated code segment that has been previously decoded and cached, and generate a trace output based on the reconstructed instruction sequence.

Another example, (e.g., example 13) relates to a previously described example (e.g., example 12), wherein the processing circuitry is further configured to insert a token representing the skipped instructions or a previously decoded instruction trace of the skipped instructions retrieved from a cache in the trace output.

Another example, (e.g., example 14) relates to a previously described example (e.g., any one of examples 12-13), wherein the processing circuitry is configured to: determine whether an instruction is a call instruction, if the instruction is a call instruction, determine whether the call instruction is a call to the set of pre-determined function calls, and if the call instruction is a call to the set of pre-determined function calls, skip decoding instructions of the called function and insert a token representing the called function or a previously decoded instruction trace of the called function retrieved from a cache in the trace output.

Another example, (e.g., example 15) relates to a previously described example (e.g., example 14), wherein the processing circuitry is configured to set a current instruction pointer to a target address of the call instruction and resume the decoding from the target address if the call instruction is not a call to the set of pre-determined function calls.

Another example, (e.g., example 16) relates to a previously described example (e.g., any one of examples 12-15), wherein the processing circuitry is configured to determine whether an instruction is a branch instruction and requires trace information to resolve a next instruction pointer, if the instruction is a taken branch, determine whether a branch target is amongst cached segments, if the branch target is amongst the cached segments, fetch a cached segment matching the branch target, and determine whether branch traces of the cached segment match with a lookahead sequence of branch traces in the trace packet stream, and if the branch traces of the cached segment match with the lookahead sequence of branch traces in the trace packet stream, advance the trace packet stream past trace packets corresponding to the cached segment without decoding instructions of the cached segment.

Another example, (e.g., example 17) relates to a previously described example (e.g., example 16), wherein the processing circuitry is configured to, if the branch target is not amongst the cached segments, cache a current active segment and record branch trace information in a new active segment.

Another example, (e.g., example 18) relates to a previously described example (e.g., any one of examples 16-17), wherein the processing circuitry is configured to, if the instruction is a not-taken branch, record branch trace information in the current active segment.

Another example, (e.g., example 19) relates to a previously described example (e.g., any one of examples 12-18), wherein the trace packet stream is generated by Processor Trace (PT).

Another example, (e.g., example 20) relates to a previously described example (e.g., example 19), wherein the trace packet stream comprises target IP (TIP) packets and taken-not-taken (TNT) packets.

Another example, (e.g., example 21) relates to a method for instruction tracing, comprising: receiving a trace packet stream generated by a processor during execution of a process, decoding the trace packet stream to reconstruct an instruction sequence executed by the processor during execution of the process, wherein instructions belonging to a set of pre-determined function calls or instructions belonging to a repeated code segment that has been previously decoded and cached are skipped in decoding the trace packet stream, and generating a trace output based on the reconstructed instruction sequence.

Another example, (e.g., example 22) relates to a previously described example (e.g., example 21), comprising inserting a token representing the skipped instructions or a previously decoded instruction trace of the skipped instructions retrieved from a cache in the trace output.

Another example, (e.g., example 23) relates to a previously described example (e.g., any one of examples 21-22), comprising: determining whether an instruction is a call instruction, if the instruction is a call instruction, determining whether the call instruction is a call to the set of pre-determined function calls, and if the call instruction is a call to the set of pre-determined function calls, skipping decoding instructions of the called function and inserting a token representing the called function or a previously decoded instruction trace of the called function retrieved from a cache in the trace output.

Another example, (e.g., example 24) relates to a previously described example (e.g., example 23), comprising setting a current instruction pointer to a target address of the call instruction and resuming decoding from the target address if the call instruction is not a call to the set of pre-determined function calls.

Another example, (e.g., example 25) relates to a previously described example (e.g., any one of examples 21-24), wherein the set of pre-determined function calls includes calls to one or more functions exported by a shared library loaded into a virtual address space of the process.

Another example, (e.g., example 26) relates to a previously described example (e.g., example 25), wherein the set of pre-determined function calls includes a call to an operating system (OS) application programming interface (API).

Another example, (e.g., example 27) relates to a previously described example (e.g., any one of examples 21-26), comprising: determining whether an instruction is a branch instruction and requires trace information to resolve a next instruction pointer, if the instruction is a taken branch, determining whether a branch target is amongst cached segments, if the branch target is amongst the cached segments, fetching a cached segment matching the branch target, and determining whether branch traces of the cached segment match with a lookahead sequence of branch traces in the trace packet stream, and if the branch traces of the cached segment match with the lookahead sequence of branch traces in the trace packet stream, advancing the trace packet stream past trace packets corresponding to the cached segment without decoding instructions of the cached segment.

Another example, (e.g., example 28) relates to a previously described example (e.g., example 27), comprising: if the branch target is not amongst the cached segments, caching a current active segment in a segment cache and recording branch trace information in a new active segment.

Another example, (e.g., example 29) relates to a previously described example (e.g., any one of examples 27-28), comprising, if the instruction is a not-taken branch, recording branch trace information in the current active segment.

Another example, (e.g., example 30) relates to a previously described example (e.g., any one of examples 21-29), wherein the trace packet stream is generated by Processor Trace (PT).

Another example, (e.g., example 31) relates to a previously described example (e.g., example 30), wherein the trace packet stream comprises target IP (TIP) packets and taken-not-taken (TNT) packets.

The aspects and features mentioned and described together with one or more of the previously detailed examples and figures, may as well be combined with one or more of the other examples in order to replace a like feature of the other example or in order to additionally introduce the feature to the other example.

Examples may further be or relate to a computer program having a program code for performing one or more of the above methods, when the computer program is executed on a computer or processor. Steps, operations or processes of various above-described methods may be performed by programmed computers or processors. Examples may also cover program storage devices such as digital data storage media, which are machine, processor or computer readable and encode machine-executable, processor-executable or computer-executable programs of instructions. The instructions perform or cause performing some or all of the acts of the above-described methods. The program storage devices may comprise or be, for instance, digital memories, magnetic storage media such as magnetic disks and magnetic tapes, hard drives, or optically readable digital data storage media. Further examples may also cover computers, processors or control units programmed to perform the acts of the above-described methods or (field) programmable logic arrays ((F)PLAs) or (field) programmable gate arrays ((F)PGAs), programmed to perform the acts of the above-described methods.

The description and drawings merely illustrate the principles of the disclosure. Furthermore, all examples recited herein are principally intended expressly to be only for pedagogical purposes to aid the reader in understanding the principles of the disclosure and the concepts contributed by the inventor(s) to furthering the art. All statements herein reciting principles, aspects, and examples of the disclosure, as well as specific examples thereof, are intended to encompass equivalents thereof.

A functional block denoted as “means for . . . ” performing a certain function may refer to a circuit that is configured to perform a certain function. Hence, a “means for s.th.” may be implemented as a “means configured to or suited for s.th.”, such as a device or a circuit configured to or suited for the respective task.

Functions of various elements shown in the figures, including any functional blocks labeled as “means”, “means for providing a sensor signal”, “means for generating a transmit signal.”, etc., may be implemented in the form of dedicated hardware, such as “a signal provider”, “a signal processing unit”, “a processor”, “a controller”, etc. as well as hardware capable of executing software in association with appropriate software. When provided by a processor, the functions may be provided by a single dedicated processor, by a single shared processor, or by a plurality of individual processors, some of which or all of which may be shared. However, the term “processor” or “controller” is by far not limited to hardware exclusively capable of executing software but may include digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included.

A block diagram may, for instance, illustrate a high-level circuit diagram implementing the principles of the disclosure. Similarly, a flow chart, a flow diagram, a state transition diagram, a pseudo code, and the like may represent various processes, operations or steps, which may, for instance, be substantially represented in computer readable medium and so executed by a computer or processor, whether or not such computer or processor is explicitly shown. Methods disclosed in the specification or in the claims may be implemented by a device having means for performing each of the respective acts of these methods.

It is to be understood that the disclosure of multiple acts, processes, operations, steps or functions disclosed in the specification or claims may not be construed as to be within the specific order, unless explicitly or implicitly stated otherwise, for instance for technical reasons. Therefore, the disclosure of multiple acts or functions will not limit these to a particular order unless such acts or functions are not interchangeable for technical reasons. Furthermore, in some examples a single act, function, process, operation or step may include or may be broken into multiple sub-acts,-functions,-processes,-operations or -steps, respectively. Such sub acts may be included and part of the disclosure of this single act unless explicitly excluded.

Furthermore, the following claims are hereby incorporated into the detailed description, where each claim may stand on its own as a separate example. While each claim may stand on its own as a separate example, it is to be noted that—although a dependent claim may refer in the claims to a specific combination with one or more other claims—other examples may also include a combination of the dependent claim with the subject matter of each other dependent or independent claim. Such combinations are explicitly proposed herein unless it is stated that a specific combination is not intended. Furthermore, it is intended to include also features of a claim to any other independent claim even if this claim is not directly made dependent to the independent claim.

1. A computer-readable medium comprising a code that, when the code is executed on a processor, causes the processor to:
receive a trace packet stream generated by a processor during execution of a process;
decode the trace packet stream to reconstruct an instruction sequence executed by the processor during execution of the process, wherein the code is configured to skip instructions belonging to a set of pre-determined function calls or instructions belonging to a repeated code segment that has been previously decoded and cached; and
generate a trace output based on the reconstructed instruction sequence.

2. The computer-readable medium of claim 1, wherein the code is configured to insert a token representing the skipped instructions or a previously decoded instruction trace of the skipped instructions retrieved from a cache in the trace output.

3. The computer-readable medium of claim 1, wherein the code is configured to:
determine whether an instruction is a call instruction;
if the instruction is a call instruction, determine whether the call instruction is a call to the set of pre-determined function calls; and
if the call instruction is a call to the set of pre-determined function calls, skip decoding instructions of the called function and insert a token representing the called function or a previously decoded instruction trace of the called function retrieved from a cache in the trace output.

4. The computer-readable medium of claim 3, wherein the code is configured to set a current instruction pointer to a target address of the call instruction and resume decoding from the target address if the call instruction is not a call to the set of pre-determined function calls.

5. The computer-readable medium of claim 1, wherein the set of pre-determined function calls includes calls to one or more functions exported by a shared library loaded into a virtual address space of the process.

6. The computer-readable medium of claim 5, wherein the set of pre-determined function calls includes a call to an operating system (OS) application programming interface (API).

7. The computer-readable medium of claim 1, wherein the code is configured to:
determine whether an instruction is a branch instruction and requires trace information to resolve a next instruction pointer;
if the instruction is a taken branch, determine whether a branch target is amongst cached segments;
if the branch target is amongst the cached segments, fetch a cached segment matching the branch target, and determine whether branch traces of the cached segment match with a lookahead sequence of branch traces in the trace packet stream; and
if the branch traces of the cached segment match with the lookahead sequence of branch traces in the trace packet stream, advance the trace packet stream past trace packets corresponding to the cached segment without decoding instructions of the cached segment.

8. The computer-readable medium of claim 7, wherein the code is configured to:
if the branch target is not amongst the cached segments, cache a current active segment in a segment cache and record branch trace information in a new active segment.

9. The computer-readable medium of claim 7, wherein the code is configured to:
if the instruction is a not-taken branch, record branch trace information in the current active segment.

10. The computer-readable medium of claim 1, wherein the trace packet stream is generated by Processor Trace (PT).

11. The computer-readable medium of claim 10, wherein the trace packet stream comprises target IP (TIP) packets and taken-not-taken (TNT) packets.

12. An apparatus for instruction tracing, the apparatus comprising processing circuitry configured to:
receive a trace packet stream generated by a processor during execution of a process;
decode the trace packet stream to reconstruct an instruction sequence executed by the processor during execution of the process, wherein decoding comprises skipping instructions belonging to a set of pre-determined function calls or instructions belonging to a repeated code segment that has been previously decoded and cached; and
generate a trace output based on the reconstructed instruction sequence.

13. The apparatus of claim 12, wherein the processing circuitry is further configured to insert a token representing the skipped instructions or a previously decoded instruction trace of the skipped instructions retrieved from a cache in the trace output.

14. The apparatus of claim 12, wherein the processing circuitry is configured to:
determine whether an instruction is a call instruction;
if the instruction is a call instruction, determine whether the call instruction is a call to the set of pre-determined function calls; and
if the call instruction is a call to the set of pre-determined function calls, skip decoding instructions of the called function and insert a token representing the called function or a previously decoded instruction trace of the called function retrieved from a cache in the trace output.

15. The apparatus of claim 14, wherein the processing circuitry is configured to set a current instruction pointer to a target address of the call instruction and resume the decoding from the target address if the call instruction is not a call to the set of pre-determined function calls.

16. The apparatus of claim 12, wherein the processing circuitry is configured to:
determine whether an instruction is a branch instruction and requires trace information to resolve a next instruction pointer;
if the instruction is a taken branch, determine whether a branch target is amongst cached segments;
if the branch target is amongst the cached segments, fetch a cached segment matching the branch target, and determine whether branch traces of the cached segment match with a lookahead sequence of branch traces in the trace packet stream; and
if the branch traces of the cached segment match with the lookahead sequence of branch traces in the trace packet stream, advance the trace packet stream past trace packets corresponding to the cached segment without decoding instructions of the cached segment.

17. The apparatus of claim 16, wherein the processing circuitry is configured to, if the branch target is not amongst the cached segments, cache a current active segment and record branch trace information in a new active segment.

18. The apparatus of claim 16, wherein the processing circuitry is configured to, if the instruction is a not-taken branch, record branch trace information in the current active segment.

19. The apparatus of claim 12, wherein the trace packet stream is generated by Processor Trace (PT).

20. A method for instruction tracing, comprising:
receiving a trace packet stream generated by a processor during execution of a process;
decoding the trace packet stream to reconstruct an instruction sequence executed by the processor during execution of the process, wherein instructions belonging to a set of pre-determined function calls or instructions belonging to a repeated code segment that has been previously decoded and cached are skipped in decoding the trace packet stream; and
generating a trace output based on the reconstructed instruction sequence.
